(19) United States
(12) Patent Application Publication
(10) Pub. No.: US 2022/0087897 A1
(43) Pub. Date: Mar. 24, 2022

(54) Vibratory Expulsive Therapy For Urinary Stones

(71) Applicant: The Regents of the University of California, Oakland, CA (US)

(72) Inventors: Marshall L. Stoller, San Francisco, CA (US); Avi Baskin, San Francisco, CA (US); David Bayne, San Francisco, CA (US); Ralph Wang, San Francisco, CA (US)

(21) Appl. No.: 17/459,160

(22) Filed: Aug. 27, 2021

Related U.S. Application Data
(60) Provisional application No. 63/072,489, filed on Aug. 31, 2020.

(51) Int. Cl. A61H 23/00

(52) U.S. Cl. CPC A61H 23/004; A61H 2201/0103; A61H 2201/1619; A61H 2201/165; A61H 2203/0406; A61H 2230/20; A61H 2203/0456; A61H 2203/0468; A61H 2230/06; A61H 2230/42; A61H 2203/0425

(57) ABSTRACT

The disclosure pertains to methods and devices for administering a vibration expulsion therapy (VET) to a subject to expulse a urinary stone. The method comprises circumferentially administering vibrations to a subject's torso to facilitate movement of a urinary stone through the urinary system or to alleviate pain associated with a urinary stone. In certain embodiments, the method comprises circumferentially administering vibrations to a subject via a vest configured to envelope and tightly fit contours on the subject's torso, particular, the subject's lower torso and cover the subject's kidneys, ureter, and/or urinary bladder. Further provided is a system comprising a processor and a computer-readable medium comprising instructions that, when executed by the processor, causes the processor to actuate a vest placed on the subject's torso to circumferentially administer vibrations to the subject's torso or a portion thereof.

### CROSS-REFERENCE TO RELATED APPLICATIONS

This application claims benefit under 35 U.S.C. § 119(e) of provisional application 63/072,489, filed Aug. 31, 2020, which is herein incorporated by reference in its entirety.

### INTRODUCTION

Between one to two million patients in the United States present to the emergency department (ED) with renal colic. Kidney stones primarily affect adults between the ages of 20-60 totaling an estimated direct cost of $4.5 billion dollars a year. The prevalence of nephrolithiasis is 11% and rising. Kidney stones are in the top 10 most frequent ED diagnoses, and of those, they are by the far the highest in cost by 2-3 fold due to time in the ED (an average of 6-7 hours) and expensive imaging modalities. While over 90% of patients evaluated in the ED are released after sufficient control of symptoms, 11% had at least one additional emergency visit for treatment of that same stone with a third of that group requiring hospitalization or urgent intervention. Additionally, the risk of repeat ionizing radiation to patients is a concern. In a nationally representative sample, 82.6% of patients had a computer tomography (CT) scan during the emergency department visit. In the course of their acute disease process, patients who were followed over a period of just 10 months received an average of 2.5 CT scans. Almost 20% of patients with nephrolithiasis receive during their first year of follow up radiation exposure above the safety threshold.

The current standard of care for symptoms of acute renal colic includes hydration, medical expulsive therapy (MET), and pain and nausea control. These methods take an average of 17 days. 40% of these patients do not pass the stone without surgical intervention. Many patients endure significant pain as the stone passes through the urinary system—pain that has been regularly compared to that of childbirth without anesthesia.

Traditionally, aggressive intravenous and oral hydration has been used to increase renal blood flow and urine production, theoretically “flushing” out the obstructive stone. While it is important to resuscitate patients who are volume deplete, there is no evidence that hyperhydration helps expedite stone passage and may increase renal colic by causing further distension of the ureter, renal pelvis and/or capsule with risk of increased pain and forniceal rupture. Non-steroidal anti-inflammatory drugs (NSAIDs) and narcotics help with short term pain relief but they do not facilitate stone passage. Additionally, NSAIDs can render patients at risk of renal impairment by preventing glomerular afferent arterial vasodilation. In the setting of an opioid epidemic, nephrolithiasis is one of the top ED diagnoses associated with an opioid prescribed at discharge. Nephrolithiasis is emerging as a risk factor for long term opioid use. MET therapy with alpha-blockers for patients with uncomplicated ureteral stones<10 mm has been recommended by the American Urologic Association. However, the vast majority of randomized control trials (RCT) have not found a benefit for MET even in distal ureteral stones>5 mm—the group that initially had been thought to benefit. Even without evidence of efficacy, many providers continue to offer alpha blockers because of the relatively low side effect profile and no other viable options. There have been more than 50 trials on medical expulsive therapy with mixed results. Therefore, there are essentially no medications to facilitate stone passage. There is an urgent need for new and effective treatments for symptom control and stone passage for patients with renal colic.

Investigators have focused on mechanical vibration as adjuvant therapy to help accelerate stone passage. Using a model of a functional pyelocalyceal system, investigators showed a proof of concept that the forces generated by a roller coaster (that did not go upside down) successfully passed kidney stones. While crude in nature, this method is like multiple interventions that has been tried in the past for stone passage including: cupped hands by a nurse or trained assistant, using hand held devices typically used for chest physiotherapy to extracorporeal physical vibrational lithecbole (EPVL)—a device composed of a primary vibrator that is placed on the ureteral/renal region as well as an auxiliary vibrator that is part of a “couch” on which the patient lays (FIG. 1). EPVL used in patients with distal ureteral stones has a 90% stone free rate 1 week after intervention as measured on CT scan compared to a 50% rate for standard of care alone. In a post procedure setting, after shock wave lithotripsy and ureteroscopy for nephrolithiasis, a metanalysis found a 55% higher relative risk of stone passage in groups who underwent vibrational therapy in the post-operative setting compared to standard of care.

In the treatment of stones, vibration invoking methods including cupped hands by a trained nurse/assistant, hand held devices typically used for chest physiotherapy, or more complex devices including vibrating couches and probes have been trialed. These treatments have shown benefit; however, they have not been adopted in a widespread fashion likely due to availability, awkward/burdensome nature, need for special equipment and trained providers, and cost. Despite these barriers, vibratory intervention has been adopted successfully for other medical conditions. For example, patients with cystic fibrosis clear respiratory secretions using vests that provide high frequency chest wall compression (HFCWC). These devices have been used by patients for years on a daily basis at home without direct medical supervision. They are safe, with minor relative risks, and rare contraindications.

Vibrational therapy can have a substantial effect on stone passage. Using ultrasonic propulsion kidney stones were repositioned in a non-invasive manner in awake and sedated patients which facilitated passage. However, there has been limited adoption of all forms of vibrational therapy due to its expensive and time consuming nature. At the least, it requires an additional trained provider and special equipment. In the setting of a busy ED, post-operative recovery unit or clinic where providers have multiple patients they are responsible for at once, providing vibration therapy or ultrasonic stone positioning in this form to patients is often unrealistic.

However, mechanical vibration therapy has been used successfully for other medical conditions. In high frequency chest wall compression (HFCWC), a vest is placed over the torso to apply percussion type treatment by oscillating the tidal volume of the vest (FIG. 2). Treatments range from 20-30 minutes. While HFCWC was originally indicated for young adults with cystic fibrosis it has now been used for many different types of patients with need for airway clearance including those who have undergone heart/lung transplant and those with respiratory dysfunction secondary to chronic neuromuscular disorders. The vests are easy to use and are often worn by patients at home without direct medical supervision, offering a distinct advantage to other forms of mechanical percussion therapy.

Thus, with the rise in the symptomatic urinary stone disease and high cost associated with ED visit and conventional treatment for passing urinary stones, alternative therapies are desirable.

### SUMMARY

This disclosure provides devices and therapies that facilitate passage of ureteral stones. These therapies are low cost, minimally invasive, and do not require trained professional for administration.

Certain embodiments of the invention provide vibrational expulsive therapy (VET) to facilitate passage of ureteral stones more rapidly and with less pain compared to conventional therapies. The disclosure provides that circumferentially administering vibrations to the torso of a subject can facilitate passage of urinary stones. Compared to conventional therapies, such stone passage can more rapidly alleviate symptoms of renal colic. VET can also be used for bladder pain management, post-surgical pain management, or ureteral stent pain management.

The disclosure also provides that different parameters, such as patient positioning, time of VET administration, and amplitude/frequency of the vibrations to control the success of the stone passage.

Further embodiments of the invention also provide a method of alleviating pain associated with urinary stone in a subject by administering vibrations to the torso of the subject.

VET is efficacious in decreasing pain and promoting ureteral stone passage and it can change the care of patients with renal colic in the ED. Moreover, devices for administering VET are inexpensive and easy to use with no expert supervision.

Certain embodiments of the invention provide vests designed for administering VET. Certain such vests provide vibrations to the torso or a portion of the torso of a subject to facilitate passage of urinary stones. In specific embodiments, vests that provide HFCWC can be used to administer vibrations to the torso of a subject to facilitate passage of urinary stones.

In some embodiments, the disclosure provides computer readable media for incorporation or control of the devices disclosed herein and for implementing the methods disclosed herein for administering a VET to a subject to expulse a urinary stone.

### BRIEF DESCRIPTION OF THE FIGURES

FIG. 1: Conventional vibration based therapies to facilitate passing of kidney stones. A: mechanical percussion by a trained assistant in an inverted patient, B: chest physiotherapy device used for renal percussion, extracorporeal physical vibrational lithecbole (C: auxiliary vibrator “couch,” D: primary vibrator).

FIG. 2: Vest Airway Clearance System (Hill-Rom, St. Paul, Minn.), used for high frequency chest wall compression (HFCWC).

FIG. 3: Chest Wall Pressure and Comfort Rating (Visual Analogue Scale) during high frequency chest wall vibratory therapy.

FIG. 4: Urodynamic tracing of patient with externalized vibrational vest (Hill-Rom, St. Paul, Minn.) at a pressure setting of 10 units and increasing frequency settings. At each frequency setting increase the abdominal pressure increased. At all frequency and pressure levels the patient was comfortable.

FIG. 5: A patient receiving Hill-Rom Vest positioned VET.

FIG. 6: An example of a vest configured to administer VET.

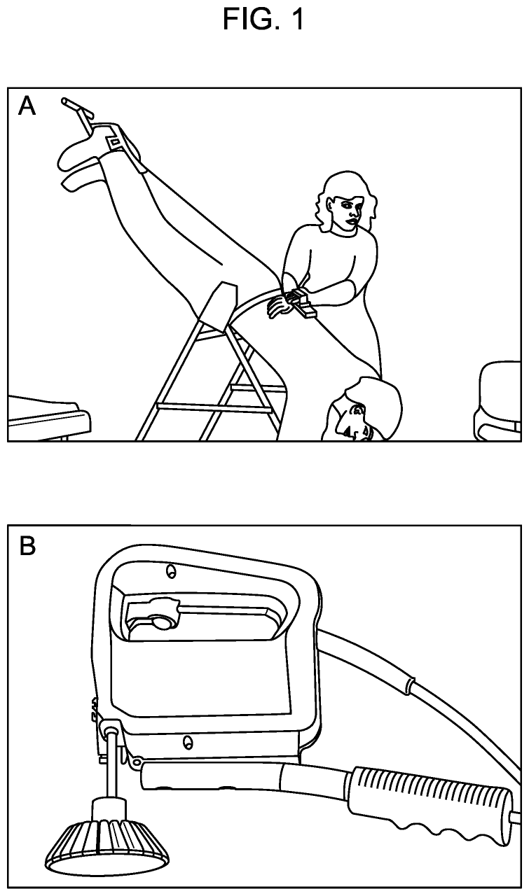

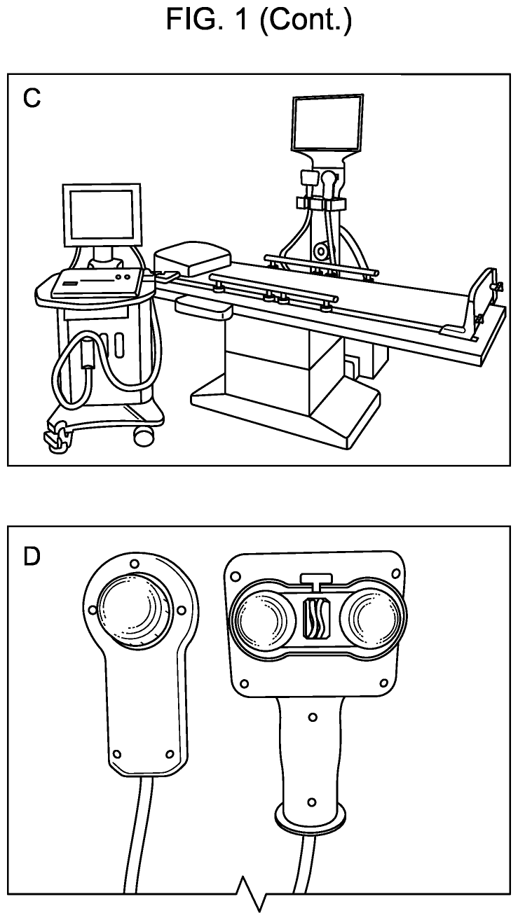

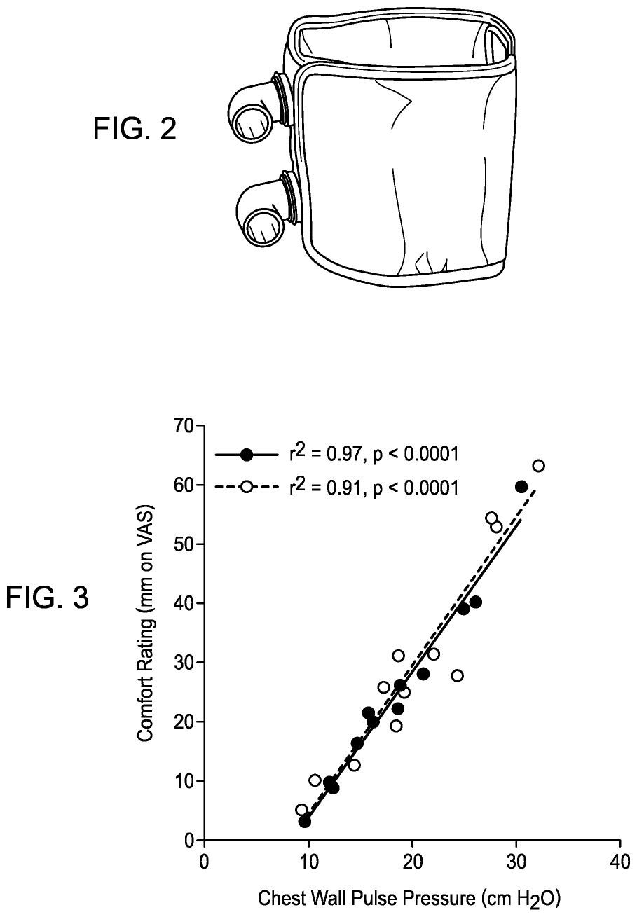

### DETAILED DESCRIPTION

Before the methods, computer-readable media, and devices of the present disclosure are described in greater detail, it is to be understood that the methods, computer-readable media, and devices are not limited to the embodiments described, as such may, of course, vary. It is also to be understood that the terminology used herein is for the purpose of describing the embodiments only, and is not intended to be limiting, since the scope of the methods, computer-readable media, and devices will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed. The upper and lower limits of these smaller ranges may independently be included in the smaller ranges and are also encompassed, subject to any specifically excluded limit in the stated range. Where the stated range includes one or both the limits, ranges excluding either or both of those included limits are also included.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which the methods, computer-readable media, and devices belong. Although any methods, computer-readable media and devices similar or equivalent to those described herein can also be used in the practice or testing of the methods, computer-readable media and devices, representative illustrative methods, computer-readable media and devices are now described.

All publications and patents cited in this specification are herein incorporated by reference as if each individual publication or patent were specifically and individually indicated to be incorporated by reference and are incorporated herein by reference to disclose and describe the materials and/or methods in connection with which the publications are cited. The citation of any publication is for its disclosure prior to the filing date and should not be construed as an admission that the present methods, computer-readable media and devices are not entitled to antedate such publication, as the date of publication provided may be different from the actual publication date which may need to be independently confirmed.

It is noted that, as used herein and in the appended claims, the singular forms “a,” “an,” and “the” include plural referents unless the context clearly dictates otherwise. It is further noted that the claims may be drafted to exclude any optional element. As such, this statement is intended to serve as antecedent basis for use of such exclusive terminology as “solely,” “only,” and the like in connection with the recitation of claim elements or use of a “negative” limitation.

It is appreciated that certain features of the methods, computer-readable media and devices, which are, for clarity, described in the context of separate embodiments, may also be provided in combination in a single embodiment. Conversely, various features of the methods, computer-readable media and devices, which are, for brevity, described in the context of a single embodiment, may also be provided separately or in any suitable sub-combination. All combinations of the embodiments are specifically embraced by the present disclosure and are disclosed herein just as if each combination was individually and explicitly disclosed, to the extent that such combinations embrace operable processes and/or compositions. In addition, all sub-combinations listed in the embodiments describing such variables are also specifically embraced by the present methods, computer-readable media and devices and are disclosed herein just as if each such sub-combination was individually and explicitly disclosed herein.

As will be apparent to those of skill in the art upon reading this disclosure, each of the individual embodiments described and illustrated herein has discrete components and features which may be readily separated from or combined with the features of any of the other several embodiments without departing from the scope or spirit of the present methods, computer-readable media, and devices. Any recited method can be carried out in the order of events recited or in any other order that is logically possible.

### Methods

Certain embodiments of the invention disclose a method for administering VET to a subject to expulse a urinary stone for facilitating passage of a urinary stone and/or alleviating a pain caused by a urinary stone.

In certain embodiments, VET comprises circumferentially administering vibrations to a subject's torso or a portion thereof. The vibrations can be simultaneously administered at a plurality of locations. The vibrations can also be sequentially administered at a plurality of locations.

In some cases, the portion of the subject's torso is the lower portion of the torso, particularly, the portion covering the kidneys, ureter, and/or urinary bladder.

The vibrations can have a frequency of between 1 Hz and 100 Hz, such as between 5 Hz and 80 Hz, between 10 Hz and 60 Hz, between 15 Hz and 40 Hz, between 20 Hz and 30 Hz, or about 25 Hz. Any suitable frequency of vibration, which can be determined on an individualized basis, can be administered.

The vibrations can be administered for a period of between 5 minutes and 60 minutes, particularly, between 10 minutes and 50 minutes, 15 minutes and 40 minutes, 20 minutes and 30 minutes, or about 25 minutes.

In some cases, along with the vibrations, pressure is also applied to the lower portion of the torso of a subject. The pressure can be between 1 to 5 PSI, particularly, 1 PSI, 2 PSI, 3 PSI, 5 PSI, or 5 PSI.

Vibrations having any combination of frequencies, periods of times, and applied pressure mentioned in the three preceding paragraphs can be administered as VET.

When VET is administered, the subject can be in a supine, a prone, an upright sitting, or an upright standing position. The subject can also be in different positions over the period of administration of VET. For example, the subject can be in a supine position for the first 10 minutes and in a prone position for the next 20 minutes.

VET can also comprise administering vibrations for a plurality of periods of between 5 minutes and 60 minutes, wherein each period of administration is followed by a lull period. The lull period can be between 1 minute and 30 minutes, such as between 5 minutes and 25 minutes, 10 minutes and 20 minutes, or about 15 minutes.

In specific embodiments, VET is administered to the subject's torso or a portion thereof via a vest placed on the subject's torso.

### Devices

Further embodiments of the invention provide vests for administering VET to a subject to expulse a urinary stone. Accordingly, certain embodiments of the invention provide a vest configured to circumferentially administer vibrations to a subject's torso or a portion thereof.

The vest can be configured to administer vibrations having a frequency of between 1 and 100 Hz, such as between 5 Hz and 80 Hz, between 10 Hz and 60 Hz, between 15 Hz and 40 Hz, between 20 Hz and 30 Hz, or about 25 Hz. The vest can be configured to administer any suitable frequency of vibration, which can be determined on an individual basis.

The vest can be configured to administer vibrations for a period of between 5 minutes and 60 minutes, such as between 10 minutes and 50 minutes, 15 minutes and 40 minutes, 20 minutes and 30 minutes, or about 25 minutes. The vest can be configured to administer any suitable period of vibration, which can be determined on an individual basis.

The vest can also be configured to administer vibrations having any combination of frequencies and periods of times mentioned in the two preceding paragraphs.

The vest can be configured to administer vibrations for a plurality of periods of between 5 minutes and 60 minutes, wherein each period of administration is followed by a lull period. The lull period can be between 1 minute and 30 minutes.

In some cases, the vest comprises a battery, preferably, a rechargeable battery. The vest can also be powered by direct electrical connection via an electrical outlet.

The vest of can comprise a vibration sensor configured to detect vibrational force of the device. The sensor can transmit the detected vibrational force reading to a monitor.

The vest can also comprise a vital sign sensor configured to detect a vital sign of the subject, such as heart rate, respiration rate, or oxygen saturation level.

The vest can also comprise a control panel configured to allow control by a user of the parameters of the vibrations delivered by the vest. Such controllable parameters of the vibrations include frequency of vibrations, duration of the time of administration, duration of the time of lull between vibrations, and the locations of the administration of vibrations.

In some cases, the vest is configured to produce vibrations via rotating unbalanced weights. The vest can also be configured to produce vibrations via air-pockets that rapidly inflate and deflate. Any other suitable mechanism for generating vibrations can be used to in the vests disclosed herein.

In preferred embodiments, the vest is configured to envelope and tightly fit contours on the subject's lower torso and cover the subject's kidneys, ureter, and/or urinary bladder.

In some cases, the same vest can be fitted onto subjects of different body sizes, for example, via the use of fastening mechanisms, such as Velcro™, buttons, or chains. Any suitable mechanism for fitting a vest onto a subject can be implemented.

### Computer-Readable Media and Devices

Also provided herein are computer readable media for incorporation into the devices disclosed herein and for implementing the methods disclosed herein for administering a VET to a subject to expulse a urinary stone.

In certain aspects, provided is a non-transitory computer readable medium including instructions for carrying out the methods disclosed herein, where the instructions, when executed by one or more processors, cause the one or more processors to implement the methods disclosed herein for administering VET to a subject to expulse a urinary stone.

Various steps of administering VET to a subject to expulse a urinary stone may be as described in the Devices and Methods sections above. For purposes of brevity, details regarding these steps and other features/elements described in the Device and Methods sections of the present disclosure are incorporated by reference but not reiterated herein. In some embodiments, the instructions, when executed by one or more processors, cause the one or more processors to perform any of the methods described in the Methods section.

Instructions can be coded onto a non-transitory computer-readable medium in the form of “programming,” where the term “computer-readable medium” as used herein refers to any non-transitory storage or transmission medium that participates in providing instructions and/or data to a computer for execution and/or processing. Examples of storage media include a hard disk, optical disk, magneto-optical disk, CD-ROM, CD-R, magnetic tape, non-volatile memory card, ROM, DVD-ROM, Blue-ray disk, solid state disk, network attached storage (NAS), etc., whether such devices are internal or external to the computer. A file containing information can be “stored” on computer readable medium, where “storing” means recording information such that it is later accessible and retrievable by a computer.

The instructions may be in the form of programming that is written in one or more of any number of computer programming languages. Such languages include, for example, Java (Sun Microsystems, Inc., Santa Clara, Calif.), Visual Basic (Microsoft Corp., Redmond, Wash.), and C++ (AT&T Corp., Bedminster, N.J.), as well as many others.

The present disclosure also provides computer devices. The computer devices include one or more processors and any of the non-transitory computer readable media of the present disclosure. Accordingly, in some embodiments, the computer devices can perform any of the methods described in the Methods section herein.

In certain aspects, a computer device of the present disclosure is a local computer device, preferably, a portable computer device, such as a smart-phone or table. In some embodiments, the computer device is a remote computer device (e.g., a remote server), meaning that the instructions are executed on a computer device different from a local computer device and/or the instructions are downloadable from the remote computer device to a local computer device, e.g., for execution on the local computer device. In some embodiments, the instructions constitute a web-based application stored on a remote server.

In some cases, the instructions for carrying out the methods disclosed herein or for controlling the vests disclosed herein are provided in the form of a software that can be installed on a portable electronic device, such as a tablet computer or a smart-phone.

The software can be configured to provide different modes of treatments, such as VETs designed for the specific treatment or prevention of a condition, such as kidney stone, bladder pain, post-surgical pain management, or ureteral stent pain. The software can communicate with the vest via wired or wireless communication to cause the vest to administer a specific VET.

The software can record the history of VETs administered to a subject. The software can also record the vital signs detected by the sensor in the vest. The software can provide feedback to the user on how the user has used the software and/or the vest in the past and recommend changes, if any, for the future use.

The software can be configured to receive input from a user regarding any adverse events, such as nausea or pain related to the use of the vest.

The software can be configured to transmit the information so recorded to a recipient system, for example, a recipient system of a healthcare provider, such as doctor or a nurse. The healthcare provider can be remotely located compared to the subject using the vest. Such transmission can be done via a cellular network. Such transmission can also be done via peer to peer connection, such as a Bluetooth™ connection or a local area network, such as a WiFi connection.

The software can also be configured to shut off the vest after a predetermined period of time.

Notwithstanding the appended claims, the present disclosure is also defined by the following embodiments:

Embodiment 1. A method for facilitating passage of a urinary stone and/or alleviating a pain caused by a urinary stone, the method comprising circumferentially administering vibrations to a subject's torso or a portion thereof.

Embodiment 2. The method of embodiment 1, wherein circumferentially administering vibrations to the subject's torso or a portion thereof comprises simultaneously administering vibrations at a plurality of locations.

Embodiment 3. The method of embodiment 1, wherein circumferentially administering vibrations to the subject's torso or a portion thereof comprises sequentially administering vibrations at a plurality of locations.

Embodiment 4. The method of any of preceding embodiments, wherein the portion of the subject's torso comprises a lower portion of the torso covering the kidneys, ureter, and/or urinary bladder.

Embodiment 5. The method of any of preceding embodiments, wherein the vibrations have a frequency of between 1 Hz and 30 Hz.

Embodiment 6. The method of any of preceding embodiments, wherein the vibrations are administered for a period of between 5 minutes and 60 minutes.

Embodiment 7. The method of any of preceding embodiments, wherein the vibrations are administered for a plurality of periods of between 5 minutes and 60 minutes, wherein each period of administration is followed by a lull period.

Embodiment 8. The method of embodiment 7, wherein the lull period is for between 1 minute and 30 minutes.

Embodiment 9. The method of any of preceding embodiments, wherein the subject is in a supine position.

Embodiment 10. The method of any of embodiments 1 to 8, wherein the subject is in a prone position.

Embodiment 11. The method of any of embodiments 1 to 8, wherein the subject is in an upright sitting position.

Embodiment 12. The method of any embodiments 1 to 8, wherein the subject is in an upright standing position.

Embodiment 13. The method of any of preceding embodiments, wherein the vibrations are administered to the subject's torso or a portion thereof via a vest placed on the subject's torso.

Embodiment 14. A vest configured to circumferentially administer vibrations to a subject's torso or a portion thereof.

Embodiment 15. The vest of embodiment 14, configured to administer vibrations having a frequency of between 1 and 100 Hz.

Embodiment 16. The vest of embodiment 14 or 15, configured to administer vibrations for a period of between 5 minutes and 60 minutes.

Embodiment 17. The vest of any of embodiments 14 to 16, configured to administer vibrations for a plurality of periods of between 5 minutes and 60 minutes, wherein each period of administration is followed by a lull period.

Embodiment 18. The vest of embodiment 17, wherein the lull period is between 1 minute and 30 minutes.

Embodiment 19. The vest of any of embodiments 13 to 18, comprising a battery.

Embodiment 20. The vest of any of embodiments 13 to 19, further comprising a vibration sensor configured to detect vibrational force of the device and transmit it back to a monitor.

Embodiment 21. The vest of any of embodiments 13 to 20, further comprising a vital sign sensor configured to detect a vital sign of the subject.

Embodiment 22. The vest of embodiment 20, wherein the vital sign is heart rate, respiration rate, or oxygen saturation level.

Embodiment 23. The vest of any of embodiments 13 to 22, further comprising a control panel configured to allow control by a user of the parameters of the vibrations delivered by the vest.

Embodiment 24. The vest of embodiment 23, wherein the parameters of the vibrations comprise frequency of vibrations, duration of the time of administration, duration of the time of lull between vibrations, and the locations of the administration of vibrations.

Embodiment 25. The vest of any of embodiments 13 to 23, wherein the vest is configured to produce vibrations via rotating unbalanced weights.

Embodiment 26. The vest of any of embodiments 13 to 23, wherein the vest is configured to produce vibrations via air-pockets that rapidly inflate and deflate.

Embodiment 27. The vest of any of embodiments 13 to 26, wherein the vest is configured to envelope and tightly fit contours on the subject's lower torso and cover the subject's kidneys, ureter, and/or urinary bladder.

Embodiment 28. A system comprising a processor and a computer-readable medium comprising instructions that, when executed by the processor, causes the processor to actuate a vest placed on the subject's torso to circumferentially administer vibrations on the subject's torso or a portion thereof.

Embodiment 29. The system of embodiment 28, wherein the computer-readable medium comprises instructions that, when executed by the processor, causes the processor to actuate the vest to deliver vibrations having a frequency of between 1 and 100 Hz.

Embodiment 30. The system of embodiment 28 or 29, wherein the computer-readable medium comprises instructions that, when executed by the processor, causes the processor to actuate the vest to deliver vibrations for a period of between 5 minutes and 60 minutes.

Embodiment 31. The system of any of embodiments 28 to 29, wherein the computer-readable medium comprises instructions that, when executed by the processor, causes the processor to actuate the vest to deliver vibrations for a plurality of periods of between 5 minutes and 60 minutes, wherein each period of administration is followed by a lull period.

Embodiment 32. The system of embodiment 31, wherein the lull period is for between 1 minute and 30 minutes.

Embodiment 33. The system of any of embodiments 28 to 32, wherein the vest is configured to envelope and tightly fit contours on the subject's lower torso and cover the subject's kidneys, ureter, and/or urinary bladder.

Embodiment 34. The system of any of embodiments 28 to 33, wherein the computer-readable medium further comprises instructions that, when executed by the processor, causes the processor to actuate the vest to deliver vibrations optimized for treatment of a condition.

Embodiment 35. The system of embodiment 34, wherein the condition is selected from a group consisting of bladder pain, stone prevention, and stone treatment.

Embodiment 36. The system of any of embodiments 28 to 35, wherein the computer-readable medium further comprises instructions that, when executed by the processor, causes the processor to monitor and record the parameters of vibrations delivered by the vest.

Embodiment 37. The system of embodiment 36, wherein the parameters of the vibrations comprise frequency of vibrations, duration of the time of administration of vibrations, duration of the time of lull between vibrations, and the locations of the administration of vibrations.

Embodiment 38. The system of any of embodiments 26 to 37, wherein the computer-readable medium further comprises instructions that, when executed by the processor, causes the processor to receive and record a vital sign detected by a sensor in the vest, wherein the sensor is configured to detect the vital sign of the subject.

Embodiment 39. The system of embodiment 38, wherein the vital sign is heart rate, respiration rate, or oxygen saturation level.

Embodiment 40. The system of any of embodiments 28 to 39, wherein the computer-readable medium further comprises instructions that, when executed by the processor, causes the processor to transmit recorded information to a recipient system.

Embodiment 41. The system of embodiment 40, wherein the recipient system is located at a remote location relative to the system.

### EXPERIMENTAL

### EXAMPLE 1

### High Frequency Chest Wall Compression (HFCWC) Vest for Administering VET

Vibratory effects and ureteral relaxation aid the passage of stones. The physiological mechanisms of vibration producing ureteral relaxation is based on animal models. Prior work in canine models show that active tension in the ureter is decreased by vibration. During stone extraction in animal models tension in the ureter was considerably lower when vibration was applied to the system. Prior usage of vibrational therapy on patients with ureteral stones has proven an effective aid in stone passage. Notably, in one report, patients reported a decrease in renal colic type pain with EPVL. No other work reported on pain control.

It is known that cutaneous vibration is able to reduce both clinical and experimental pain. Similarly, VET disclosed herein benefits patients with renal colic. The disclosure provides that the force delivered to the body by HFCWC would be able to deliver significant vibrational force to the urinary tract to facilitate passage of urinary stones.

In HFCWC, one third of the chest wall pressure is transmitted into the pleural space. The chest oscillation device has both a background pressure setting (ranging from 1-10 based on manufacturer setting, no units) and frequency ranging from 5-25 Hz. Typically, the pressure is between 1 to 5 PSI. Various combinations of background pressure and oscillation frequency on esophageal pulse pressure were tested as a surrogate for pleural pressure. Esophageal pulse pressure was highly correlated with chest wall pressure and at all times. Importantly, intrapleural pressure during a typical therapeutic session of HFCWC is safe as much higher pressures are experienced during normal physiologic states such as coughing, exercise and sneezing. Additionally, as chest wall pressure increases, comfort as measured on the visual analog scale (VAS) decreased (FIG. 3). It is important to note the few absolute contraindications to chest wall vibrational therapy including unstable head or neck injury, active hemorrhage, and hemodynamic instability. HFCWC is very well tolerated and has high patient satisfaction.

### EXAMPLE 2

### Urodynamic Tracing of Patient with External Vibrational Vest

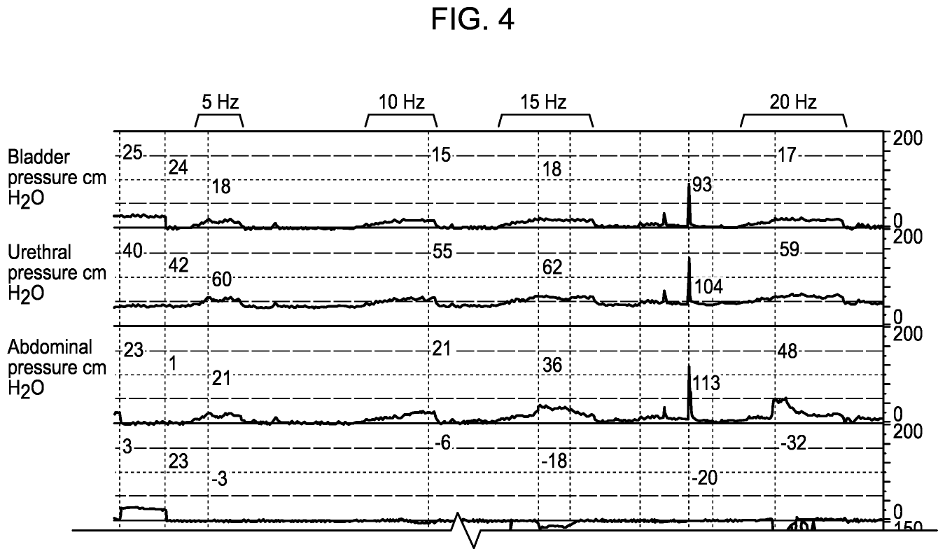

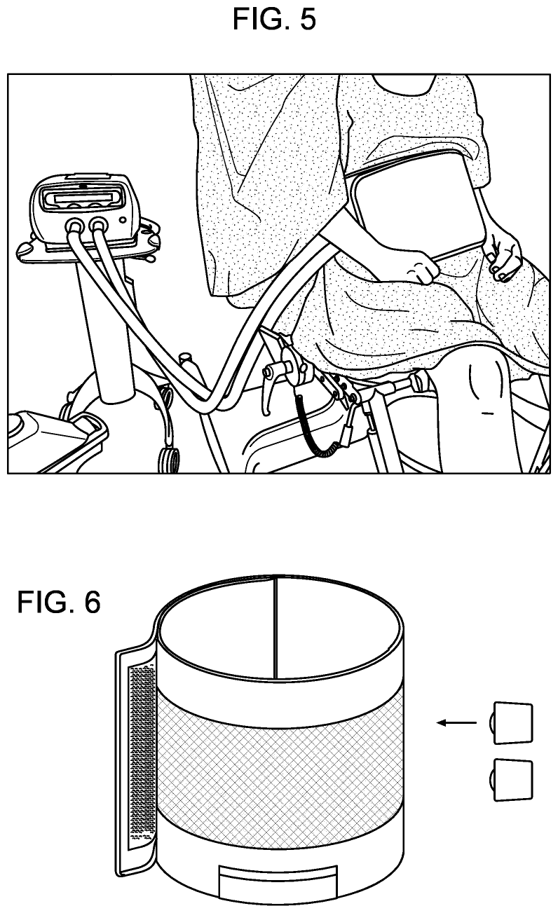

Using a HFCWC device positioned around the abdomen in a patient undergoing urodynamics for another indication, increasing frequency was found to correlate with increasing abdominal and bladder pressure. (FIGS. 4 and 5). The therapy was started at 5 Hz and increased up to 20 Hz over the period of the study. Pressure setting was set at maximum at 10 units (manufacturer's setting, no SI unit). The abdominal pressure was measured by a catheter placed in the rectum and the bladder pressure was measured by a catheter in the bladder.

These findings are interpreted as a proof of concept that the external vibratory therapy can be used to create sufficient force on the retroperitoneum and lower abdomen. Of note, the patient did not report any pain from the vibratory therapy and was comfortable throughout. Further, a more efficient transfer of vibratory therapy to the abdomen is expected because there is no chest wall/thorax to diminish the percussive effect. Mechanical vibration with similar frequencies to HFCWC has been efficacious in stone passage. EPVL functions with the mobile vibrator at 40-60 Hz and the stationary couch the patient lays on at 20-30 Hz. Chest physiotherapy with a mechanical chest percussor is typically set between 20-50 Hz depending on the device.

In summary, the above data in combination with prior work indicate the efficacy of VET for stone passage and/or to treat the symptoms of renal colic. Thus, the proposed VET provides easy to perform and well tolerated nonpharmacologic intervention for patients with acute renal colic.

### EXAMPLE 3

### Optimization of VET for Patients who Present to the ED with Renal Colic Secondary to Ureteral Stones

VET provides an easy to utilize and well tolerated therapy with high patient satisfaction and a low side effect profile for patients with renal colic secondary to ureteral stones. VET is also easy to administer to patients in the ED. Further, certain parameters can be optimized for individualized VET application and delivery for patients in the ED.

Patients older than 18 years of age and having obstructive nephrolithiasis and ureteral stones≤10 mm would be enrolled into an optimization study. The size of the ureteral stones can be confirmed using CT imaging. These patients are candidates for traditional treatments with medical expulsion therapy.

Patients with certain criteria would be excluded from the study, such as patients having: hemodynamic instability, urinary tract infection, fever defined as >38.0° C., known genitourinary abnormalities including prior surgical reconstruction of the upper tract and transplanted or solitary kidney, kidney injury as defined by creatinine>2 mg/dL, pregnancy, known contraindications to the Vest Airway Clearance system including open wounds and rib/spine fractures.

Administering VET: The vest will be worn around the lower torso and overlap the kidneys, ureter, and bladder. Three parameters would be tested independently—patient positioning (supine vs. sitting), time of VET (30 vs. 45 minutes), and amplitude/frequency of the vibrations.

For each patient the initial amplitude administered would be 10 units, which is the highest setting for the commercially available device (this is the highest possible setting) and a frequency of 5 Hz. The frequency can be slowly changed to the maximum of 20 Hz. Frequency and/or pressure could be adjusted for patients who cannot tolerate the intervention secondary to pain or other discomfort.

### EXAMPLE 4

### The Devices and Methods of the Invention used to Administering VET to a Subject to Expulse a Urinary Stone

A pilot study of VET vs. standard of care in patients with renal colic would be conducted. At least 100 patients would enrolled during the study period. To understand the role of VET therapy on urinary stone patients, following aspects of the therapy would be studied:

Optimizing the use of VET for patients who present to the ED with renal colic secondary to ureteral stones. VET would be easy to administer, well tolerated, with high patient satisfaction and would exhibit low side effect profile for patients with renal colic secondary to ureteral stones. To optimize the usage of VET, 10 patients would be enrolled in a pilot study. Three parameters would be tested independently—patient positioning, treatment time of VET, and amplitude/frequency of the vibrations. Patients would be followed for one month after the ED visit.

Perform a prospective pilot RCT comparing VET to placebo for patients in the ED who present with renal colic secondary to ureteral stones. VET would facilitate more rapid stone passage and better symptom control compared to standard of care therapy in patients with renal colic. Cooling vests would be utilized as a sham placebo intervention in the control group. Patients with non-contrast computer tomography (CT) imaging of ureteral stones will be evaluated for the primary outcomes of stone passage/progression. Secondary outcomes will include pain and nausea, medication requirements in the ED, return ED visits, complications, time in the ED, and need for surgical intervention for stones. Patients will be followed after discharge for 4 weeks to determine time to stone passage, complications and need for surgical intervention.

VET would be efficacious in decreasing pain and promoting ureteral stone passage and would change the care of patients with renal colic in the ED. Devices that can be used for VET are low cost, easy to use with no expert supervision and some alternatives for such devices may be available at hospitals. Thus, VET offers a non-pharmacologic mechanism to help patients expel urinary stones faster, with decreased pain, and higher patient satisfaction.

1. A method for facilitating passage of a urinary stone and/or alleviating a pain caused by a urinary stone, the method comprising circumferentially administering vibrations to a subject's torso or a portion thereof.

2. The method of claim 1, wherein circumferentially administering vibrations to the subject's torso or a portion thereof comprises simultaneously administering vibrations at a plurality of locations.

3. The method of claim 1, wherein circumferentially administering vibrations to the subject's torso or a portion thereof comprises sequentially administering vibrations at a plurality of locations.

4. The method of claim 1, wherein the portion of the subject's torso comprises a lower portion of the torso covering the kidneys, ureter, and/or urinary bladder.

5. The method of claim 1, wherein the vibrations have a frequency of between 1 Hz and 30 Hz.

6. The method of claim 1, wherein the vibrations are administered for a period of between 5 minutes and 60 minutes.

7. The method of claim 1, wherein the vibrations are administered for a plurality of periods of between 5 minutes and 60 minutes, wherein each period of administration is followed by a lull period.

8. The method of claim 7, wherein the lull period is for between 1 minute and 30 minutes.

9. The method of claim 1, wherein the subject is in a supine position.

10. The method of claim 1, wherein the subject is in a prone position.

11. The method of claim 1, wherein the subject is in an upright sitting position.

12. The method of claim 1, wherein the subject is in an upright standing position.

13. The method of claim 1, wherein the vibrations are administered to the subject's torso or a portion thereof via a vest placed on the subject's torso.

14. A vest configured to circumferentially administer vibrations to a subject's torso or a portion thereof.

15. The vest of claim 14, configured to administer vibrations having a frequency of between 1 and 100 Hz.

16. The vest of claim 14, configured to administer vibrations for a period of between 5 minutes and 60 minutes.

17. The vest of claim 14, configured to administer vibrations for a plurality of periods of between 5 minutes and 60 minutes, wherein each period of administration is followed by a lull period.

18. The vest of claim 17, wherein the lull period is between 1 minute and 30 minutes.

19. The vest of claim 13, comprising a battery.

20. The vest of claim 13, further comprising a vibration sensor configured to detect vibrational force of the device and transmit it back to a monitor.

21. The vest of claim 13, further comprising a vital sign sensor configured to detect a vital sign of the subject.

22. The vest of claim 20, wherein the vital sign is heart rate, respiration rate, or oxygen saturation level.

23. The vest of claim 13, further comprising a control panel configured to allow control by a user of the parameters of the vibrations delivered by the vest.

24. The vest of claim 23, wherein the parameters of the vibrations comprise frequency of vibrations, duration of the time of administration, duration of the time of lull between vibrations, and the locations of the administration of vibrations.

25. The vest of claim 13, wherein the vest is configured to produce vibrations via rotating unbalanced weights.

26. The vest of claim 13, wherein the vest is configured to produce vibrations via air-pockets that rapidly inflate and deflate.

27. The vest of claim 13, wherein the vest is configured to envelope and tightly fit contours on the subject's lower torso and cover the subject's kidneys, ureter, and/or urinary bladder.

28.-41. (canceled)
